(19) United States
(12) Patent Application Publication
(10) Pub. No.: US 2026/0222640 A1
(43) Pub. Date: Jul. 30, 2026

(54) UNIFIED RECOMMENDATION SYSTEM

(71) Applicant: Pinterest, Inc., San Francisco, CA (US)

(72) Inventors: Siddarth Reddy Malreddy, Mountain View, CA (US); Lianghao Chen, San Jose, CA (US); Matthew William Chun, San Francisco, CA (US); Dhruvil Deven Badani, San Francisco, CA (US); Yuming Chen, Shoreline, WA (US); Usha Amrutha Nookala, Sunnyvale, CA (US); Yujuan Song, Seattle, WA (US)

(73) Assignee: Pinterest, Inc., San Francisco, CA (US)

(21) Appl. No.: 19/038,254

(22) Filed: Jan. 27, 2025

(51) Int. Cl. H04N 21/25; H04N 21/258

(52) U.S. Cl. CPC H04N 21/252; G06Q 30/0255; G06Q 30/06311; G06Q 30/06313; H04N 21/25891

(57) ABSTRACT

Disclosed are systems and methods for unified content item ranking across multiple output channels that provide personalized content item recommendations while adapting to different output channel contexts. A machine learning model receives four sets of data for each candidate content item: user engagement history data, content item popularity data, content item information data, and contextual relevance data. The contextual relevance data includes both a query context associated with an output channel and a content relevance based on existing content. The model generates engagement scores for multiple types of engagement actions, which are then weighted according to output channel-specific parameters to produce final ranking scores. By using a single unified model that automatically adapts its scoring behavior based on the specific output channel, the system reduces engineering complexity while maintaining optimized recommendations across diverse output channels such as style-based recommendations, topic-based landing pages, and personalized shopping interfaces.

### BACKGROUND

Content discovery platforms, such as recommendation systems, social media networks, etc., face significant challenges in helping users discover relevant content across diverse browsing experiences and contexts. Traditional recommendation systems often require maintaining separate ranking models for different output channels, such as topic-specific landing pages, new user experiences, and shopping interfaces. Each ranking model typically has its own specialized logic for content selection and ranking, leading to substantial computational overhead and duplicated development efforts. This siloed approach makes it difficult to share insights and improvements across different recommendation contexts, potentially resulting in inconsistent user experiences. Additionally, when new types of browsing experiences need to be added, significant engineering resources must be devoted to developing and maintaining new ranking models specific to those experiences. The challenge is further complicated by the need to balance multiple competing factors when ranking content, including user engagement history, content popularity, content characteristics, and contextual relevance specific to each browsing experience.

### BRIEF DESCRIPTION OF THE DRAWINGS

FIGS. 1A and 1B are a transition diagram illustrating an example transition between a client device and a unified recommendation system in which the unified recommendation system provides content items to one of a plurality of output channels for presentation, according to exemplary implementations of the present disclosure.

FIG. 2 is a block diagram illustrating additional details of the unified recommendation system discussed with respect to FIGS. 1A and 1B, according to exemplary implementations of the present disclosure.

FIG. 3 is a block diagram illustrating example inputs and outputs to the Scoring machine learning model discussed with respect to FIG. 2, according to exemplary implementations of the present disclosure.

FIG. 4 is an example unified recommendation system process, according to exemplary implementations of the present disclosure.

FIG. 5 is an example engagement scoring process, according to exemplary implementations of the present disclosure.

FIG. 6 is an example engagement scores weighting process, according to exemplary implementations of the present disclosure.

FIG. 7 is an example machine learning model training process, according to exemplary implementations of the present disclosure.

FIG. 8 is a block diagram illustrating an exemplary computing resource, according to exemplary implementations of the present disclosure.

### DETAILED DESCRIPTION

Content discovery platforms face a significant challenge in helping users find relevant content items across many different output channels. For example, a user might browse content items through a personalized homepage feed, topic-specific landing pages, style-based recommendations, or contextual suggestions based on their previous interactions. Traditional approaches typically require maintaining separate ranking systems for each of these output channels, with each system having its own logic for determining what content items to show and in what order. This creates substantial computing and resource overhead, as each new output channel requires building and maintaining its own specialized ranking system. Moreover, insights and improvements gained from one ranking system often cannot be applied to other ranking systems of other output channels, leading to inconsistent user experiences and duplicated development efforts.

The disclosed implementations address these challenges through a unified recommendation system that dynamically adapts to different output channels. The disclosed implementations utilize a single machine learning model (“ML model”), such as a wide and deep neural network, that considers one or more universal sets of input data for the different output channels. The universal sets of input data may include, for example: a set of user engagement history data, a set of content item popularity data, a set of content item information data, and a set of contextual relevance data specific to each output channel. The set of contextual relevance data includes both a query context and a content relevance. A “set,” as used herein, includes one or more content items. A content item, as used herein, is any type of item that is presentable through an output channel. Example content items include images, videos, audio, etc.

Unlike traditional approaches, the disclosed implementations automatically learn how to weight the sets of data differently based on where and how content items will be presented to users. For example, when recommending content items through a style module output channel, more importance may be placed on the query (e.g., Bohemian style women's fashion) than the content items of the output channel. Comparatively, if the query is a user provided collection name (e.g., Green Kitchen Ideas) for a collection that includes a plurality of user selected content items, the disclosed implementations may give more weight to the content items of the collection over the user provided name of the collection.

The disclosed implementations significantly reduce computing resources required to maintain a different recommendation system for each output channel. The disclosed implementations also provide improved functioning of computing resources by enabling rapid deployment of new output channels, as each new output channel can leverage the same underlying unified ranking system while maintaining its own optimization goals. The disclosed implementations also ensure consistent quality across all output channels by sharing learned improvements across the entire platform rather than limiting them to specific output channels.

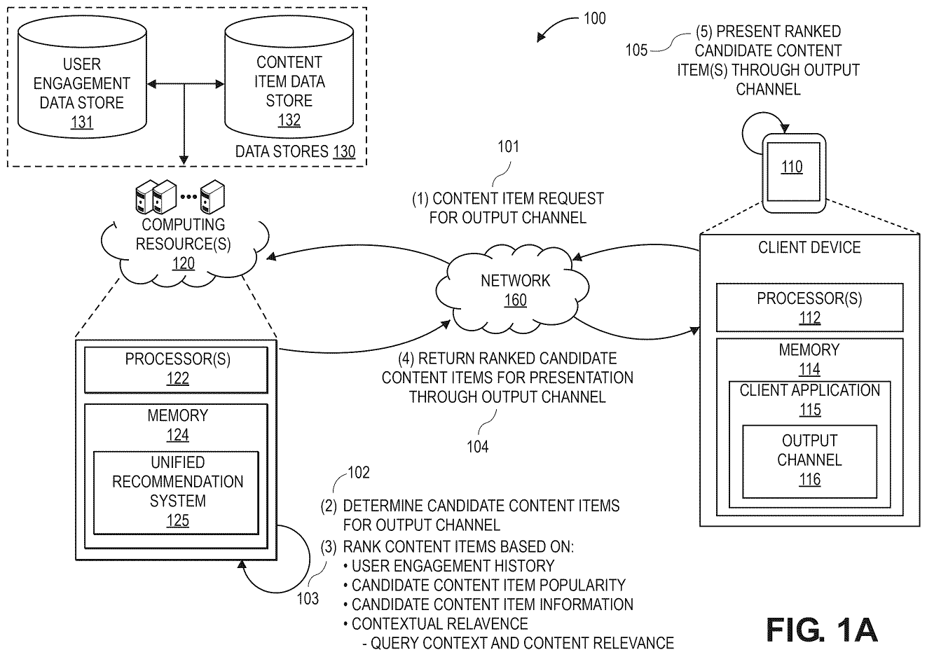

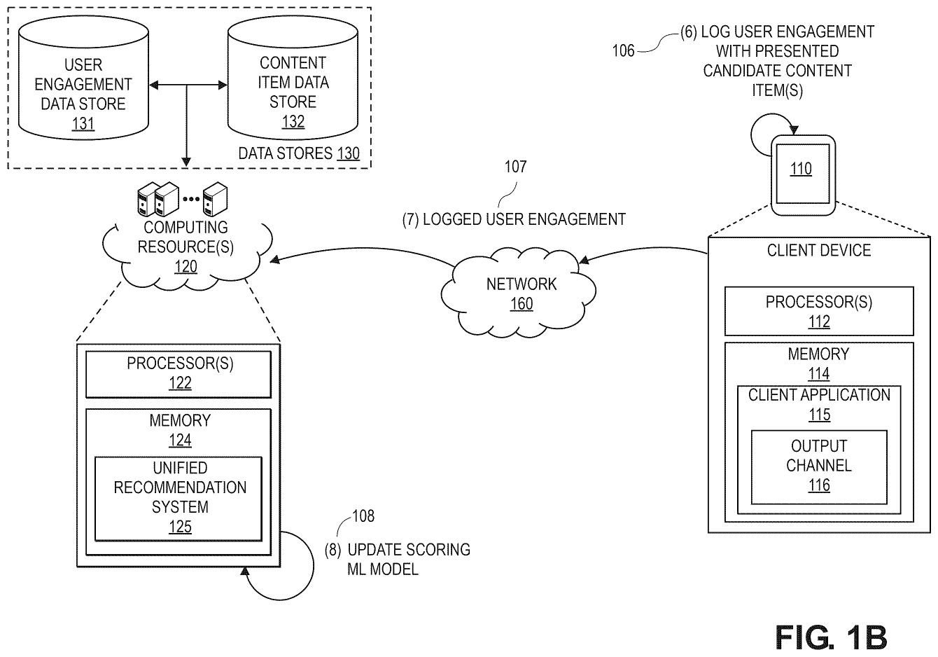

FIGS. 1A and 1B are a transition diagram 100 illustrating an example transition between a client device 110 and a unified recommendation system 125 in which the unified recommendation system 125 provides content items to one of a plurality of output channels 116 for presentation by the client device 110, according to exemplary implementations of the present disclosure. While the example discussed with respect to FIGS. 1A and 1B describes interaction between the unified recommendation system 125 and a single client device 110 for presentation of content items through a single output channel 116, it will be appreciated that the unified recommendation system 125 may simultaneously perform the described transition and/or other aspects of the disclosed implementations with multiple client devices and/or multiple output channels.

The example transition 100 discussed with respect to FIGS. 1A and 1B begins with the client device 110 sending, via network 160, a content item request 101 for content items that are to be presented through an output channel 116. While the example transition 100 describes the content item request as initiating from the client device, in other implementations, the content item request may originate from another source. For example, the content item request 101 may be generated by the unified recommendation system 125, by another service (e.g., social media network, etc.), etc. Generally, the content item request 101 may originate from any source or location.

As shown, the client device 110 may include any type of computing device, such as a smartphone, tablet, laptop computer, desktop computer, wearable, etc., and network 160 may include any wired or wireless network (e.g., the Internet, cellular, satellite, Bluetooth®, Wi-Fi®, etc.) that can facilitate communications between client device 110 and computing resources 120. The client device 110 may include one or more processors 112 and one or more memory 114, which may store one or more client applications 115, such as a web browser, social networking application, shopping application, etc. Likewise, as discussed further below, content items may be presented through one or more output channels 116, through the client application 115.

As illustrated, the content item request 101 is transmitted from the client device 110, through the network 160, to a unified recommendation system 125 operating on the one or more computing resources 120. Computing resources 120 may include one or more processor(s) 122 and one or more memory 124, which may store one or more applications, such as the unified recommendation system 125, etc., that may be executed by processor(s) 122 to cause the processor(s) 122 of computing resources 120 to perform various functions and/or actions discussed herein.

According to aspects of the present disclosure, computing resources 120 may represent at least a portion of a networked computing system that may be configured to provide online applications, services, computing platforms, servers, and the like, such as a social networking service, social media platform, e-commerce platform, content recommendation systems, search services, shopping services, and the like, that may be configured to execute on a networked computing system. Further, computing resources 120 may communicate with one or more data store(s) 130, such as user engagement data store 131 and content item data store 132, and/or other data stores.

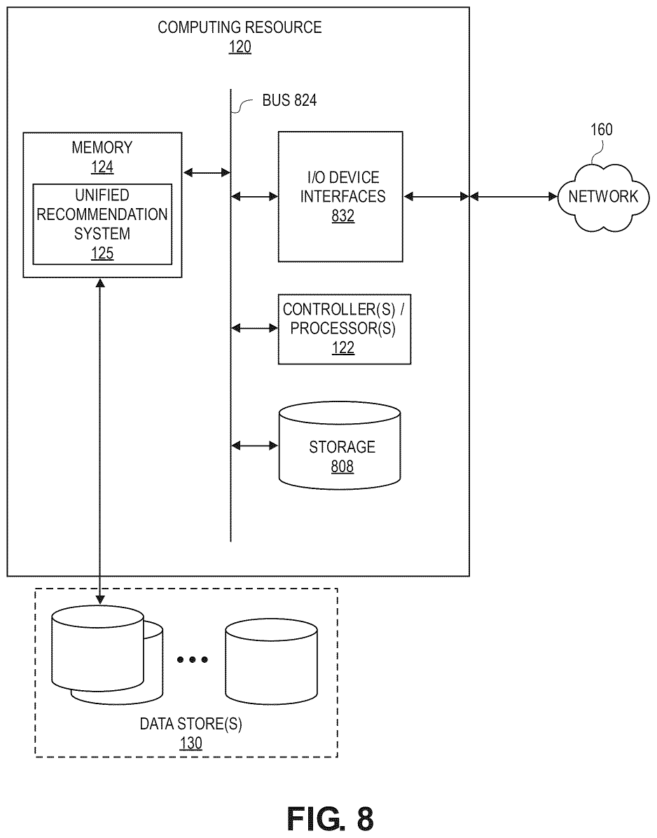

According to exemplary implementations of the present disclosure, computing resources 120 may be representative of computing resources that may form a portion of a larger networked computing platform (e.g., a cloud computing platform, and the like), which may be accessed by client device 110. Computing resources 120 may provide various services and/or resources and do not require end-user knowledge of the physical premises and configuration of the system that delivers the services. For example, computing resources 120 may include “on-demand computing platforms,” “software as a service (SaaS),” “infrastructure as a service (IaaS),” “platform as a service (PaaS),” “platform computing,” “network-accessible platforms,” “data centers,” “virtual computing platforms,” and so forth. As shown in FIGS. 1A and 1B, computing resources 120 may be configured to execute and/or provide a social media platform, a social networking service, a recommendation system, a search service, an e-commerce platform, or any other form of interactive computing. Example components of a remote computing resource, which may be used to implement computing resources 120, are discussed below with respect to FIG. 8.

The unified recommendation system 125, upon receipt of the content item request determines, at 102, a plurality of candidate content items for the output channel 116. Any of a variety of candidate content item generators may be used to generate a plurality of candidate content items. In some implementations, each output channel 116 may be defined to utilize one of a plurality of content item generators. In such implementations, the content item generator for the output channel may query the content item data store 132 and select a plurality of candidate content items.

In other implementations, any of a variety of other candidate content item generators may be utilized. Example content item generators include, but are not limited to, interest-based heuristics candidate content item generators, image-to-image based content item generators, search-based content item generators, seed-based content item generators, related item content item generators, etc. In still other examples, all content items of the content item data store 132 may be selected as candidate content items.

Upon determination or receipt of candidate content items, the unified recommendation system 125, at 103, ranks the candidate content items based on one or more different sets of data determined for each candidate content item. As discussed further below, the different sets of data include a set of user engagement history data, a set of candidate content item popularity data, a set of candidate content item information data, and a set of contextual relevance data. The set of contextual relevance data includes a query context associated with the output channel and a content relevance based on the existing content of the output channel. As discussed further below, by using these four sets of data in which the contextual relevance data includes both a query context associated with the output channel and a corresponding content relevance, the unified recommendation system may utilize a single ML model to generate engagement scores that are specific to each output channel of a plurality of output channels. The single ML model utilized by the unified recommendation system 125 and discussed in further detail below, is referred to herein as a “Scoring ML model.”

Upon generation of engagement scores for each of the candidate content items, the unified recommendation system 125 ranks the candidate content items. In some implementations, the unified recommendation system 125 may generate a ranking score for each candidate content item by combining the engagement scores determined by the Scoring ML model for the candidate content item. In other examples, the unified recommendation system 125 may apply one or more output channel-specific weights to some or all of the engagement scores to increase/decrease importance of those scores. In such an example, after applying the output channel-specific weights, the unified recommendation system 125 may combine the weighted engagement scores to generate a ranking score for each candidate content item. Finally, the unified recommendation system 125 may generate a ranked list based on the ranking score generated for each candidate content item.

After generating the ranked list of candidate content items, at 104, the unified recommendation system 125 may send, via the network 160, the ranked list, or the candidate content items indicated on the ranked list back to the client device 110 for presentation through the output channel 116 of the client application 115. The client device 110 and/or the client application 115 executing on the client device 110, upon receipt of the ranked list obtains one or more of the top ranked candidate content items and presents the obtained content items through the output channel 116. If the client device 110 is obtaining the top ranked candidate content items indicating on the ranking list, the client device 110 may obtain the candidate content items from the unified recommendation system 125, directly from the content item data store 132, and/or may already have some or all of the candidate content items maintained in a memory 114 of the client device. In other examples, if the unified recommendation system 125 sends one or more top ranked candidate content items, the client application 115 may receive and present some or all of the top ranked candidate content items through the output channel 116.

Turning now to FIG. 1B, at 106, the client device 110, or the client application 115 operating on the client device, may log actual user engagement (and non-engagement) with candidate content items presented through the output channel 116. User engagement with a content item may include, but is not limited to, a save of the content item, a click engagement (e.g., selection of the candidate content item, visiting an outbound link of the candidate content item), a long click engagement (e.g., a selection of the content item for more than a defined period of time (e.g., 10 seconds), visiting an output link of the candidate content item for more than the defined period of time), a close-up engagement, a hide engagement, a short click engagement (e.g., a selection of the content item for less than a defined period of time (e.g., 5 seconds), visiting an output link of the candidate content item for less than the defined period of time), a share engagement, a shop engagement, etc.

The client device 110, at 107, sends the logged user engagement, via the network 160, to the unified recommendation system 125 operating on the computing resources 120. In some implementations, the logs may be periodically sent in batches based on, for example, batch size and/or defined transmission frequency. In other implementations, the logs may be sent as they are generated. In still other examples, the client device 110 may only send logs upon request by the unified recommendation system 125.

The unified recommendation system 125, at 108, updates the Scoring ML model utilizing logs received from one or more devices 110 that include actual user engagement with content items through different output channels 116. By using actual user engagement collected for different users of different devices as they engage with content items through different channels, the unified recommendation system 125 evolves and improves as more actual user data is logged. Likewise, the updates also ensure that, for each output channel, the unified recommendation system 125 adapts to changes in user behavior, newly added content, and existing content items becoming less popular.

The example transition discussed with respect to FIGS. 1A and 1B may be performed between the unified recommendation system and any number of client devices 110, any number of client applications 115, and any number of output channels 116. As discussed herein, the disclosed unified recommendation system 125 is able to determine, rank, and provide candidate content items to different client devices, different client applications, and/or different output channels using a single Scoring ML model.

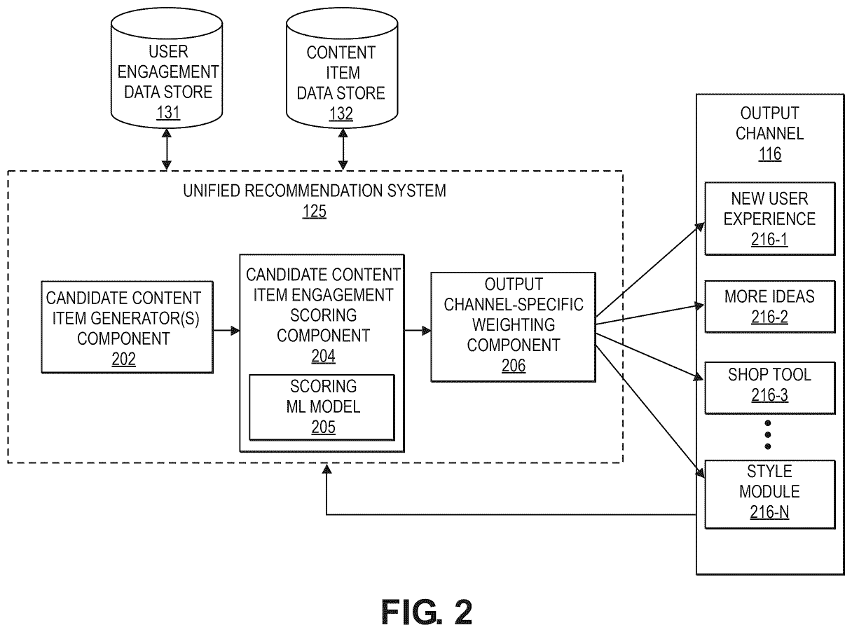

FIG. 2 is a block diagram illustrating additional details of the unified recommendation system 125 discussed with respect to FIGS. 1A and 1B, according to exemplary implementations of the present disclosure.

The unified recommendation system 125 includes a candidate content item generator(s) component 202, a candidate content item engagement scoring component 204, which includes and/or accesses the Scoring ML model 205, and an output channel-specific weighting component 206. The unified recommendation system 125 communicates with a content item data store 132 and a user engagement data store 131 to obtain information used in generating and ranking candidate content items for presentation through one or more output channels 116.

The candidate content item generator(s) component 202 queries the content item data store 132 to obtain candidate content items that may be presented through an output channel 116. In some implementations, the candidate content item generator(s) component 202 may include multiple different types of candidate generators, such as interest-based heuristics generators, image-to-image based generators, search-based generators, seed-based generators, related item generators, etc. Different output channels 116 may utilize different candidate generators or combinations of candidate generators to obtain appropriate candidate content items for the specific output channel 116. The unified recommendation system 125 may identify and utilize a subset of candidate generators based on, for example, historical performance in specific output channels.

The candidate content item engagement scoring component 204 receives the candidate content items from the candidate content item generator(s) component 202 and generates engagement scores for different types of user engagement with each candidate content item. As discussed further below, the candidate content item engagement scoring component 204 may utilize the Scoring ML model 205 to generate engagement scores for the different types of user engagement with each candidate content item. In some implementations, the Scoring ML model 205 may be implemented as a wide and deep neural network that considers one or more primary sets of data as inputs for each candidate content item. In some implementations, the one or more primary sets of data include a set of user engagement history data, a set of content item popularity data, a set of content item information data, and a set of contextual relevance data. The set of contextual relevance data includes both a query context corresponding to the output channel and a content relevance related to the query context.

The set of user engagement history data may include sequence patterns of user interactions, biographic features (age, gender, language, country, etc.), user engagement with different content items and/or different output channels, user sequences of past engagements on different output channels as sequences, etc. The set of content item information data may include, for example, content item performance scores, candidate generator source, content item quality metrics (height/width/resolution/source), content item color, objects in the content item, engagement-based embeddings, content-based embeddings, search history, fatiguing-based features at different time intervals (e.g., number of times a user has viewed/interacted with the content item, the number of user impressions on the content item, the number of engagement actions on the content item inside the output channel), etc. Content item popularity data may include, but are not limited to, platform-wide engagement scores, platform-wide trending scores, platform-wide viral scores, platform-wide time-based popularity scores, output channel engagement scores, output channel trending scores, output channel viral scores, output channel time-based popularity scores, etc.

The set of contextual relevance data includes both query context data and content relevance data. Query context data may include semantic relevance between the candidate content item and the output channel. For example, the semantic relevance may be between the candidate content item and one or more of the output channel title, name, metadata, style categories for style-based output channels, demographic information for new user experience output channels, content item collection names for content item collection-based recommendation output channels, etc. Content relevance data may include any one or more of visual similarities between the candidate content item and content items of the output channel (e.g., using max/min/median aggregations), textual similarities between the candidate content item and content items of the output channel (e.g., using text embeddings, topic similarities using interests or annotations), graph similarities between the candidate content item and the content items of the output channel (e.g., using distance and statistics between the candidate content item to content item graphs of the output channel), semantic relevance between the candidate content item and existing output channel content items, etc.

The output channel-specific weighting component 206 determines and applies output channel-specific weights to the engagement scores generated by the candidate content item engagement scoring component 204. The output channel-specific weights may be user provided and/or automatically learned based on historical user engagement patterns specific to each output channel 116. The unified recommendation system 125 may optimize the output channel-specific weights using techniques such as Bayesian optimization or genetic algorithms. Alternatively, or in addition thereto, the output-channel specific weight may be manually configured based on business objectives or goals for the different output channels 116. The output channel-specific weighting component 206 may maintain different weights and/or weighting functions for different output channels or use a unified weighting function across all output channels.

The output channel-specific weighting component 206 applies the output channel-specific weights to the engagement scores determined by the candidate content item engagement scoring component 204 to generate weighted engagement scores. The output channel-specific weighting component 206 then combines the weighted engagement scores to generate ranking scores for each candidate content item that determine the order in which candidate content items will be presented. This order may be maintained in a candidate content item ranked list.

The unified recommendation system 125 serves multiple different types of output channels 116, including but not limited to a new user experience output channel 216-1, a more ideas experience output channel 216-2, a shop tool output channel 216-3, and a style module output channel 216-N. The unified recommendation system 125 may also serve other output channels such as landing pages from search engines, and unified refinements/hybrid search experiences. Each output channel 216-1 through 216-N may have different objectives, user interaction patterns, and ranking priorities. For example, in a style-based output channel, the unified recommendation system 125 may place more importance on the query context (e.g., “Bohemian style women's fashion”), while for a user-generated collections of content items, the unified recommendation system 125 may give more weight to the saved content items in the collection than the collection name itself.

In operation, when a request is received for any output channel 116, the unified recommendation system 125 activates the appropriate candidate content item generator(s) component 202 to obtain candidate content items, processes these items through the candidate content item engagement scoring component 204 to generate engagement scores, and applies output channel-specific weights through the weighting component 206 to produce final ranking scores for each candidate content item. As discussed further below, the unified recommendation system 125 periodically updates the Scoring ML model 205 and/or the output channel-specific weights based on logged user engagement data collected across all output channels. For example, the logged user engagement data collected across the different output channels may be utilized as labeled training data to further train the Scoring ML model 205.

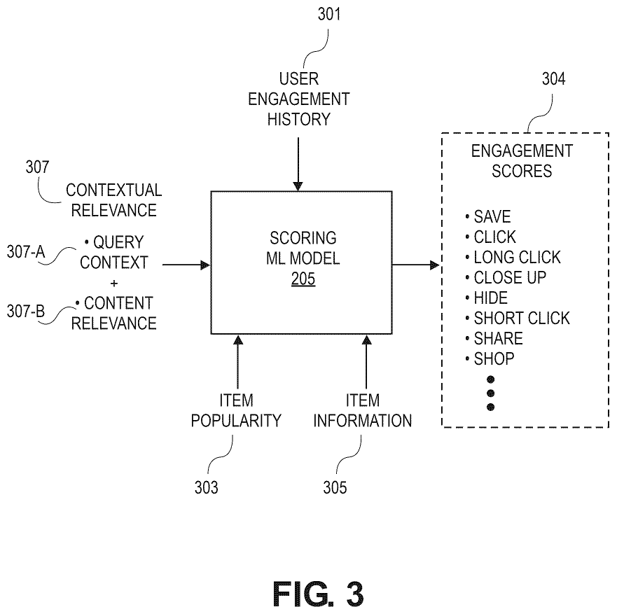

FIG. 3 is a block diagram illustrating example inputs and outputs to the Scoring ML model 205 discussed with respect to FIG. 2, according to exemplary implementations of the present disclosure.

As shown in the illustrated example, the Scoring ML model 205 receives four sets of input data: user engagement history data 301, item popularity data 303, item information data 305, and contextual relevance data 307. The contextual relevance data 307 include both query context data 307-A and content relevance data 307-B. Based on these sets of input data, the Scoring ML model 205 generates engagement scores 304 indicating likelihoods of different types of user engagement with a candidate content item corresponding to the sets of input data.

The user engagement history data 301, as discussed above with respect to FIG. 2, may include, but is not limited to, sequence patterns of user interactions, biographic features (age, gender, language, country, etc.), user engagement with different content items and/or different output channels, user sequences of past engagements on different output channels as sequences, etc.

The item popularity data 303 may include platform-wide engagement metrics and output channel-specific engagement metrics. Platform-wide metrics may include, but are not limited to, overall engagement rates, trending scores indicating rapid increases in engagement, viral scores measuring how quickly content items spread through user interactions, and time-based popularity scores showing engagement patterns over different time periods. Output channel-specific scores may include similar measurements but calculated only for interactions within specific output channels. In some implementations, the item popularity data may be segmented, for example at a demographic level. For example, item popularity data may be segmented by what is most popular by gender, age, etc.

The item information data 305 may include both static and dynamic characteristics of content items. Static characteristics may include, but are not limited to, image quality metrics (e.g., resolution, dimensions, source), visual characteristics (e.g., colors, identified objects, style categories), and textual metadata. Dynamic characteristics may include performance scores, candidate generator source identifiers, engagement-based embeddings derived from user interaction patterns, content-based embeddings capturing semantic and visual features of the content items, fatiguing-based features indicating how frequently a user has interacted with the content item over different time intervals, historical engagement metrics specific to each output channel, etc. In some implementations, fatiguing-based features may include, but are not limited to, a number of times a user has viewed or interacted with a particular content item, a number of impressions on a particular content item, a number of engagement actions a user has taken on content items within an output channel, and a number of engagements with similar content items across all output channels.

The contextual relevance data 307 uniquely combine both query context 307-A and content relevance 307-B to enable the Scoring ML model 205 to adapt its scoring behavior based on where and how content items will be presented. The query context 307-A may include semantic relevance between a candidate content item and output channel-specific context such as output channel titles, output channel style categories, user-provided collection names, etc. The content relevance 307-B may include visual, textual, and semantic similarities between the candidate content item and existing content items associated with the output channel. In some implementations, these similarities may be computed using various aggregation methods (e.g., maximum, minimum, median) across different similarity metrics. For example, similarity between a text query and candidate content items may be derived by engagement, semantic relevance, metadata matching, and/or the query. Similarity between the text query and the candidate content items may consider what is typically engaged with when a given content item is in the context.

Based on these sets of input data 301, 303, 305, 307, the Scoring ML model 205 generates engagement scores 304 for different types of potential user engagement actions. As illustrated, these engagement actions may include, but are not limited to, save actions where users save content items to their own collections, click actions indicating basic interaction, long click actions suggesting sustained attention, close up actions where users examine content items in detail, hide actions indicating negative feedback, short click actions suggesting brief or possibly accidental interaction, share actions where users distribute content items to others, and shop actions where users engage with shopping-related features. As will be appreciated, any number or engagement actions may be scored in accordance with the disclosed implementations and those provided herein are for exemplary purposes only. The engagement scores 304 represent predicted likelihoods of each type of engagement action occurring if the candidate content item is presented to the user through the specific output channel.

In some implementations, the Scoring ML model 205 may be implemented as a wide and deep neural network trained on historical user engagement data across multiple output channels. The model may employ different architectural components to process different types of input data. For example, sequence models may process user engagement history, convolutional networks may process visual features, and attention mechanisms may process contextual relevance data. The Scoring ML model 205 may be trained using pointwise and/or pairwise approaches, with the pointwise approach predicting absolute engagement probabilities for a content item and the pairwise approach learning relative preferences between pairs of candidate content items.

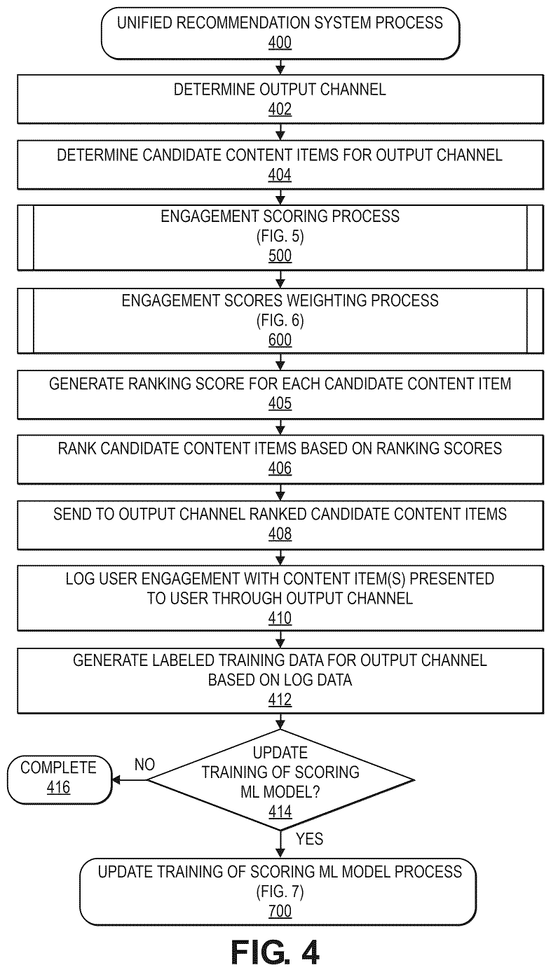

FIG. 4 is an example unified recommendation system process 400, according to exemplary implementations of the present disclosure. The unified recommendation system process 400 may be performed by one or more components of the unified recommendation system 125 to provide ranked content items to different output channels while adapting to channel-specific requirements and contexts.

The unified recommendation system 125 first determines an output channel 116 for which recommended content items are to be provided, as in 402. Output channels may include, but are not limited to, new user experience channels 216-1, more ideas channels 216-2, shop tool channels 216-3, and style module channels 216-N. As noted above, with the disclosed implementations, any of a variety or newly added output channels may be determined and recommended content items provided to those output channels.

The candidate content item generator(s) component 202 of the unified recommendation system 125 determines candidate content items for the output channel 116, as in 404. In some implementations, a candidate content items generator component 202 may employ different candidate generation strategies based on the output channel type. For example, for a style output channel, the candidate content items generation component may identify candidate content items matching determined style categories, while for a more ideas channel, the candidate content items generation component may identify content items similar to previously saved content items.

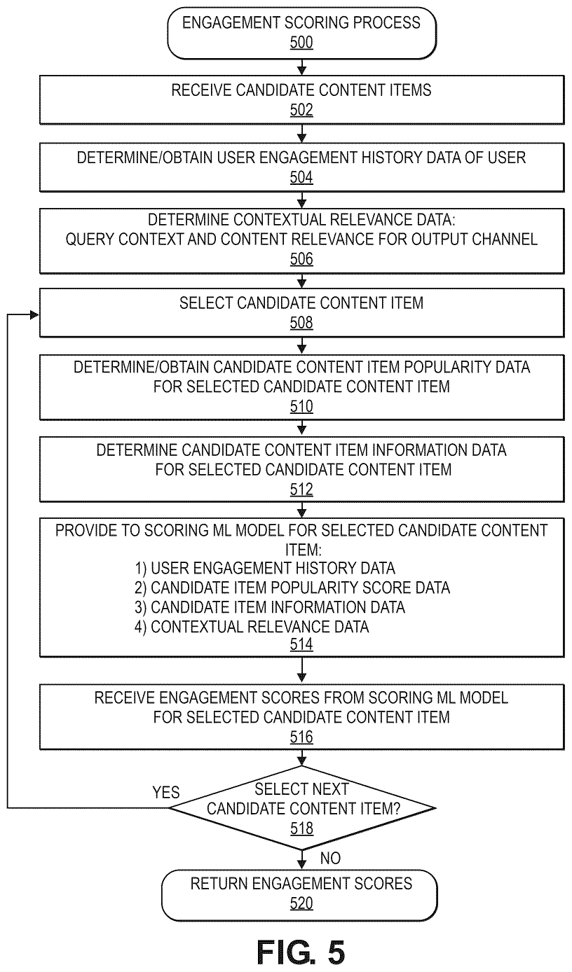

The candidate content item engagement scoring component 204 of the unified recommendation system 125 then performs an engagement scoring process, as in 500. As detailed FIG. 5, the candidate content item engagement scoring component 204 may utilize the Scoring ML model 205 to generate engagement scores for each determined candidate content item. For example, the Scoring ML model 205 may process four sets of input data: user engagement history data 301, candidate content item popularity data 303, candidate content item information data 305, and contextual relevance data 307, including both a query context 307-A and a content relevance 307-B specific to the output channel.

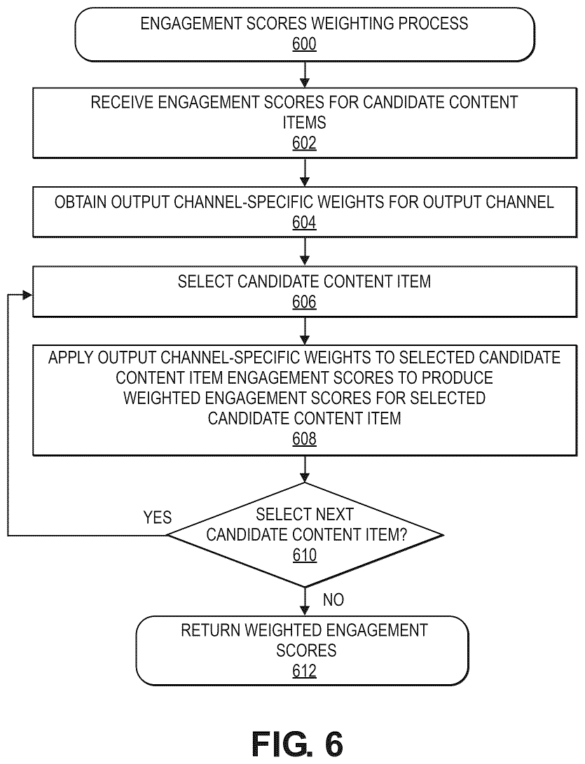

Based on the engagement scores generated by the candidate content item engagement scoring component 204, the output channel-specific weighting component 206 of the unified recommendation system 125 performs an engagement scores weighting process, as in 600. The output channel-specific weighting component 206, as discussed further below with respect to FIG. 6, applies output channel-specific weights to the engagement scores generated by the candidate content item engagement scoring component 204. These output channel-specific weights adjust the relative importance of different types of engagement actions (e.g., saves, clicks, shares) based on the goals and/or characteristics of the specific output channel 116. As will be appreciated, output channel-specific weights may differ across different channels. For example, a shopping channel may assign higher weights on shopping engagement related outcomes. Comparatively, a style module may apply higher weights to sharing type of related outcomes.

The unified recommendation system 125, based on the weighted engagement scores, generates a ranking score for each candidate content item, as in 405. For example, the weighted engagement scores may be summed, a weighted sum, averaged, or otherwise combined, to generate a ranking score for each candidate content item. In other examples, the ranking score may be generated based on other conditions and/or intents. For example, the user intent (e.g., shopping, browsing) of a user to which the content items are to be presented may be determined. The ranking score may be aligned based on that intent such that the weighed engagement scores are combined to emphasize candidate content items corresponding to the determined intent.

Based on the ranking scores, the unified recommendation system 125 ranks the candidate content items, as in 406. For example, the ranked candidate content items may be ordered from highest ranked score to lowest in a ranked score. The unified recommendation system 125 then sends the ranked list and/or the ranked candidate content items for presentation through the output channel 116, as in 408.

The unified recommendation system 125 and/or the client application 115 may then log actual user engagement (or non-engagement) with the candidate content items presented through the output channel 116, as in 410. These logs capture various types of user engagements with presented content items including, but not limited to, saves, clicks, long clicks, close-ups, hides, short clicks, shares, and shop actions. The unified recommendation system 125 may then generate labeled training data for the output channel based on the logged engagement data, associating the input data provided to the Scoring ML model 205 with the actual user engagement outcomes, as in 412.

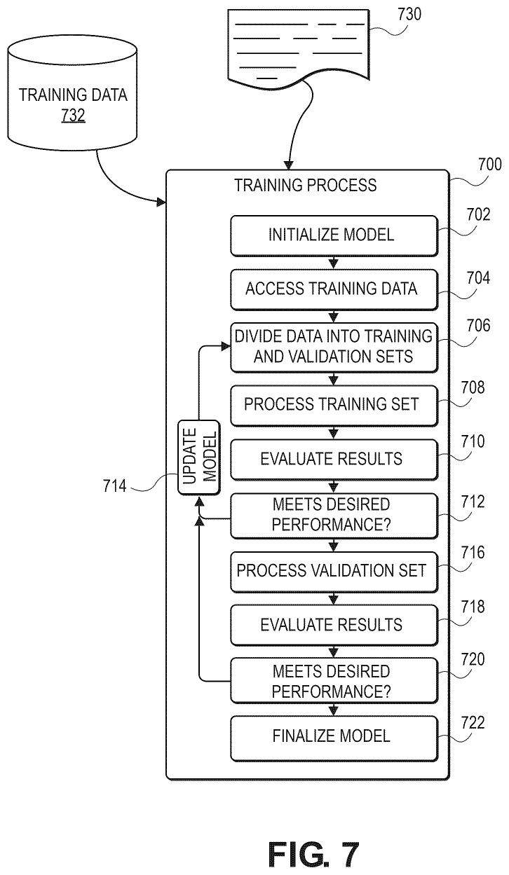

The unified recommendation system 125 may then determine whether to update the training of the Scoring ML model 205, as in 414. This determination may be based on various factors including the amount of new training data collected, observed changes in user behavior patterns, or scheduled retraining intervals. For example, retraining may be performed daily, weekly, monthly, etc. In other implementations, retraining may be done when a defined amount of logged data that may be used as training data has been received from each of the different output channels. If it is determined that the Scoring ML model 205 is to be updated, the unified recommendation system 125 causes an ML model training process to be performed, as in 700. The Scoring ML training or retraining process 700 is discussed further below with respect to FIG. 7. If it is determined that no update is needed, the example process 400 completes, as in 416. Through this continuous feedback loop of collecting engagement data and updating the Scoring ML model 205, the unified recommendation system 125 maintains and improves its ability to provide relevant content recommendations across diverse output channels while adapting to evolving user preferences and behavior patterns.

FIG. 5 is an example engagement probability scoring process 500, according to exemplary implementations of the present disclosure. The example process may be performed by the candidate content item engagement scoring component 204 of the unified recommendation system 125.

The candidate content item engagement scoring component 204 begins by receiving or generating the candidate content items determined for the output channel, as in 502. As discussed above, the candidate content items may be generated by any of a variety of candidate content item generators based on the specific output channel type.

The candidate content item engagement scoring component 204 also determines or obtains a user engagement history for the user to which content items will be presented, as in 504. The user engagement history may include, but is not limited to, historical interactions with content items across different output channels, including but not limited to patterns of saves, clicks, long clicks, close-ups, hides, short clicks, shares, and shop actions. In some implementations, the user engagement history may include user engagement for a defined period of time (e.g., current session, last X sessions, last Y days, etc.). In other implementations, the user engagement history may be weighted such that more recent user engagements receive a higher weight/consideration than older user engagements.

The candidate content item engagement scoring component 204 then determines the contextual relevance for the output channel, which includes both a query context and a content relevance, as in 506. For example, for a style-based output channel, the query context may be a style category (e.g., Bohemian style women's fashion) while the content relevance may be based on existing content items associated with that style. For a collection-based output channel, the query context may be a collection name (e.g., “Green Kitchen Ideas”) while the content relevance may be based on the existing content items saved to that collection. The candidate content item engagement scoring component 204 considers both the query context and the content relevance to balance between relevance to the query and consistency with existing content. Further, as the candidate content item engagement scoring component 204 learns information about the different output channels, the candidate content item engagement scoring component 204 may assign more or less importance/weight to the query context compared to the content relevance.

The candidate content item engagement scoring component 204 selects a candidate content item for scoring, as in 508, and determines or obtains a popularity score for the selected candidate content item, as in 510. The popularity score may reflect platform-wide engagement metrics as well as output channel-specific engagement metrics for the selected candidate content item. The candidate content item engagement scoring component 204 also determines candidate content item information for the selected candidate content item, as in 512. The candidate content item information may include visual/or and semantic characteristics of the content item such as genre, color, objects, etc., present in the content. Still further, the candidate content item information may indicate or include style features, annotations, and other descriptive attributes of the candidate content item.

The candidate content item engagement scoring component 204 then provides the four sets of data (user engagement history data, contextual relevance data, candidate content item popularity data, and candidate content item information data) to the Scoring ML model 205, as in 514. The Scoring ML model 205 processes the input sets of data and generates engagement scores predicting the likelihood of different types of user engagement with the selected candidate content item in the specific output channel context.

The candidate content item engagement scoring component 204 receives the engagement scores from the Scoring ML model 205 for the selected candidate content item, as in 516. The candidate content item engagement scoring component 204 then determines whether there are additional candidate content items to score, as in 518. If there are more candidate content items to score, the candidate content item engagement scoring component 204 returns to block 508, selects the next candidate content item, and continues. If it is determined that all candidate content items have been scored, the candidate content item engagement scoring component 204 provides the engagement scores determined for each candidate content item, as in 520.

FIG. 6 is an example engagement scores weighting process 600, according to exemplary implementations of the present disclosure. The example process 600 may be performed by the output channel-specific weighting component 206 of the unified recommendation system 125.

The output channel-specific weighting component 206 receives the engagement scores generated by the candidate content item engagement scoring component 204 through the process described in FIG. 5, as in 602. These engagement scores represent predicted likelihoods of different types of user engagement actions for each candidate content item when the candidate content item is presented though a specific output channel.

The output channel-specific weighting component 206 determines or obtains output channel-specific weights for the output channel through which the candidate content items will be presented, as in 604. These output channel-specific weights determine the relative importance of different engagement actions based on the purpose and/or characteristics of each output channel. For example, for a style module output channel focused on shopping engagement, the weights may emphasize share volume per output channel, shop engagement, and content item share metrics, while for a collection more ideas output channel, the weights may prioritize contextual relevance and collection-specific engagement patterns.

The output channel-specific weighting component 206 then selects a candidate content item for weighting, as in 606, and applies the output channel-specific weights to the engagement scores for that candidate content item, as in 608. This weighting process effectively adjusts the engagement scores output by the Scoring ML model 205 to align the importance of the different engagement types with the specific goals of the output channel. The weighting may be applied differently to different types of engagement scores based on business objectives and/or historical performance data. For example, in a style module, the output channel-specific weighting component 206 may apply higher weights to engagement scores related to shopping engagement metrics, while in a new user experience (NUX) output channel, the weights may emphasize discovery and exploration-related engagement scores.

The output channel-specific weighting component 206 then determines whether there are additional candidate content items to weight, as in 610. If it is determined that there are additional candidate content items to weight, the output channel-specific weighting component 206 returns to block 606, selects a next candidate content item, and continues. If it is determined that all candidate content items have been weighted, the output channel-specific weighting component 206 returns the weighted engagement scores for all candidate content items, as in 612. These weighted engagement scores serve as input to the ranking process described in FIG. 4, where they are used to determine the final ranking score and ordering of content items for presentation through the output channel.

Output channel-specific weights may be determined through various approaches. In some implementations, the weights are automatically learned based on historical user engagement patterns specific to each output channel, similar to how the Scoring ML model 205 learns from actual user engagement data. For example, the disclosed implementations may analyze user interaction patterns to identify primary engagement metrics for each output channel and adjust output channel-specific weights accordingly. For example, engagement data may show that users engaging with the style module are more likely to make purchasing decisions, leading to higher weights for shopping-related engagement scores. In other implementations, the weights may be assigned or adjusted manually to guide business objectives for the output channel. Similar to updating the training of the Scoring ML model 205, the output channel-specific weights may be periodically updated.

FIG. 7 is a flow diagram of an exemplary training process 700 for training an example Scoring ML model 205, such as a deep and wide neural network, that may be used to generate engagement scores, according to exemplary implementations of the present disclosure. The example process 700 may be performed by the unified recommendation system 125 and/or the candidate content item engagement scoring process 204 of the unified recommendation system 125.

As shown in FIG. 7, training process 700 is configured to train the Scoring ML model 205, or to update the training of the Scoring ML model 205. In the course of training, as shown in FIG. 7, at step 702, the unified recommendation system 125 causes the Scoring ML model 205 to be initialized with training criteria 730. Training criteria 730 may include, but is not limited to, information as to a type of training, the number of layers to be trained, etc. For example, the training criteria may specify the type and forms of input data to be received and processed, the number and dimensions of layers of the ML model to be trained, etc.

At step 704 of training process 700, the unified recommendation system 125 accesses a corpus of training data 732. For example, if the Scoring ML model 205 is being initially trained, the training data 732 may include data collected from different output channels over a period of time. If the example process 700 is being used to update a training of the Scoring ML model 205, the training data 732 may include training data generated from log files of the different output channels, as discussed above. The training data may be labeled or unlabeled training data. Labeled training data may include one or more of the four sets of data (user engagement history data, content item popularity data, content item information data, and contextual relevance data) as the inputs and actual user engagement actions (saves, clicks, long clicks, close-ups, hides, short clicks, share actions, shop action, etc.) as labels. In some implementations, the unified recommendation system 125 may implement various optimization techniques, such as sample weighting during training to adjust the importance of training data from different output channels, down sampling data for popular modules to prevent domination, etc.

With training data 732 accessed, at step 706, the unified recommendation system 125 divides the training data 732 into training and validation sets. Generally speaking, the items of data in the training set are used to train the Scoring ML model 205 and the items of data in the validation set are used to validate the training of the Scoring ML model 205. As those skilled in the art will appreciate, and as described below in regard to much of the remainder of training process 700, there are numerous iterations of training and validation that occur during the training of the Scoring ML model 205.

At step 708 of the training process 700, the unified recommendation system 125 causes the Scoring ML model 205 to process the data items of the training set, often in an iterative manner. Processing the data items of the training set includes capturing the processed results. After processing the items of the training set, at step 710, the unified recommendation system 125 aggregates and evaluates the results produced by the Scoring ML model 205, and at step 712, determines whether a desired accuracy level has been achieved. If the desired accuracy level is not achieved, in step 714, the unified recommendation system 125 updates aspects, such as loss functions, weights, etc., of the Scoring ML model 205 in an effort to guide the Scoring ML model to generate more accurate results, and processing returns to step 706, where a new set of training data is selected, and the process repeats. Alternatively, if the desired accuracy level is achieved, training process 700 advances to step 716.

At step 716, and much like step 708, the unified recommendation system 125 causes the Scoring ML model 205 to process data items of the validation set. At step 718, the unified recommendation system 125 aggregates and evaluates the results of the processing of the validation set performed by the Scoring ML model 205. At step 720, the unified recommendation system 125 determines whether a desired accuracy level, in processing the validation set, has been achieved. If the desired accuracy level is not achieved, in step 714, the unified recommendation system 125 updates aspects, such as loss functions, weights, etc., of the Scoring ML model 205 in an effort to guide the Scoring ML model to generate more accurate results, and processing returns to step 706. Alternatively, if the desired accuracy level is achieved, the training process 700 advances to step 722.

At step 722, a finalized, trained/updated Scoring ML model 205 is generated. Typically, though not exclusively, as part of finalizing the Scoring ML model 205, portions of the Scoring ML model that are included in the model during training for training purposes are extracted, thereby generating a more efficient Scoring ML model 205.

FIG. 8 is a block diagram illustrating an exemplary computing resource 120, according to exemplary implementations of the present disclosure.

In exemplary implementations, multiple such computing resources 120 may be included in the system. Further, it is noted that computing resource 120 is a logical configuration and is not necessarily an actual configuration. Indeed, there may be numerous ways in which computing resource 120 may be implemented, and FIG. 8 should be viewed as illustrative and not limiting. In operation, each of these devices (or groups of devices) may include computer-readable and computer-executable instructions that reside on computing resource 120, as will be discussed further below.

Computing resource 120 may include one or more controllers/processors 122, that may each include one or more central processing units (“CPU”) and/or graphics processing units (“GPU”) for processing data and computer-readable instructions, and memory 124 for storing data and instructions. Memory 124 may individually include volatile RAM, non-volatile ROM, non-volatile MRAM, and/or other types of memory. Computing resource 120 may also include a data storage component 808 for storing data, user actions, content items, user information, user history, content information, other supplemental information, etc. Each data storage component may individually include one or more non-volatile storage types such as magnetic storage, optical storage, solid-state storage, etc. Computing resource 120 may also be connected to removable or external non-volatile memory and/or storage (such as a removable memory card, memory key drive, networked storage, etc.) through input/output device interfaces 832. For example, the computing resource 120 may be connected to and store/retrieve data from data stores 130, such as the user engagement data store 131, the content item data store 132, etc.

Computer instructions for operating computing resource 120 and its various components may be executed by the controller(s)/processor(s) 122, using memory 124 as temporary “working” storage at runtime. The computer instructions may be stored in a non-transitory manner in non-volatile memory 124, storage 808, or an external device(s). Alternatively, some or all of the executable instructions may be embedded in hardware or firmware on computing resource 120 in addition to or instead of software.

For example, memory 124 may store program instructions that when executed by the controller(s)/processor(s) 122 cause the controller(s)/processors 122 to execute the unified recommendation system 125 discussed herein, execute components of the unified recommendation system 125, such as the Scoring ML model 205, etc.

Computing resource 120 also includes input/output device interface 832 that connects the computing resource 120 with one or more networks 160, such as the Internet. A variety of components may be connected through input/output device interface 832. Additionally, computing resource 120 may include address/data bus 824 for conveying data among components of computing resource 120. Each component within computing resource 120 may also be directly connected to other components in addition to (or instead of) being connected to other components across bus 824.

The disclosed implementations discussed herein may be performed on one or more computing resources, such as computing resource 120 discussed with respect to FIG. 8 or performed on a combination of one or more computing resources. Further, the components of the computing resource 120, as illustrated in FIG. 8, are exemplary, and may be located as a stand-alone device or may be included, in whole or in part, as a component of a larger device or system.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Persons having ordinary skill in the field of computers, communications, image processing, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein and/or that some steps or components discussed herein may be performed serially or in parallel.

Aspects of the disclosed system may be implemented as a computer method or as an article of manufacture such as a memory device or non-transitory computer-readable storage medium. The computer-readable storage medium may be readable by a computer and may comprise instructions for causing a computer or other device to perform processes described in the present disclosure. The computer-readable storage media may be implemented by a volatile computer memory, non-volatile computer memory, hard drive, solid-state memory, flash drive, removable disk, virtual drive, and/or other media.

The data and/or computer-executable instructions, programs, firmware, software and the like (also referred to herein as “computer-executable” components) described herein may be stored on a computer-readable medium that is within or accessible by computers or computer components such as computing resource 120, client device 110, or to any other computers or control systems, and having sequences of instructions which, when executed by one or more processors (e.g., CPU, GPU), cause the one or more processors to perform all or a portion of the functions, services, systems, and/or methods described herein. Such computer-executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Some implementations of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage media of the present disclosure may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, virtual drives, remote drives, or other types of media/machine-readable medium that may be suitable for storing electronic instructions. Further, implementations may also be provided as a computer-executable program product that includes a transitory machine-readable signal (in compressed or uncompressed form).

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow chart shown in FIGS. 4 through 7, orders in which such methods or processes are presented are not intended to be construed as any limitation on the claimed inventions, and any number of the method or process steps or boxes described herein can be combined in any order and/or in parallel to implement the methods or processes described herein. Additionally, it should be appreciated that the detailed description is set forth with reference to the accompanying drawings, which are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed is:

1. A computer-implemented method, comprising:
receiving a request for content items for presentation through a first output channel of a plurality of output channels;
obtaining a plurality of candidate content items from one or more candidate content item generators;
for each candidate content item of the plurality of candidate content items:
determining a set of user engagement history data for a user to which the content items are to be presented;
determining a set of content item popularity score data for the candidate content item;
determining a set of content item information data for the candidate content item;
determining a set of contextual relevance data, including:
a query context associated with the first output channel, and
a content relevance based on existing content items corresponding to the query context;
generating a plurality of engagement scores by providing the set of user engagement history data, the set of content item popularity score data, the set of content item information data, and the set of contextual relevance data to a machine learning model (“ML model”), the ML model trained on user engagement data across the plurality of output channels, each of the plurality of engagement scores corresponding to an engagement action of a plurality of engagement actions; and
generating a ranking score for the candidate content item by combining at least two of the plurality of engagement scores; and
providing, based at least in part on the ranking scores, at least one of the candidate content items for presentation through the first output channel.

2. The computer-implemented method of claim 1, wherein the first output channel comprises one of: a style-based recommendation output channel, a collection-based recommendation output channel, a new user onboarding output channel, or a shopping recommendation output channel.

3. The computer-implemented method of claim 1, further comprising:
logging engagement data across the plurality of output channels; and
updating the ML model based at least in part on the logged engagement data.

4. The computer-implemented method of claim 1, further comprising:
generating a plurality of weighted engagement scores by adjusting at least one of the plurality of engagement scores based at least in part on a plurality of first output channel-specific weights corresponding to the first output channel; and
wherein generating the ranking score further includes combining at least two of the plurality of weighted engagement scores.

5. The computer-implemented method of claim 1, wherein determining the set of contextual relevance data includes:
determining the query context based at least in part on a semantic relevance between the candidate content item and a title of the first output channel; and
determining the content relevance based at least in part on a visual similarity between the candidate content item and one or more content items of the first output channel.

6. A system, comprising:
one or more processors; and
a memory storing program instructions that, when executed by the one or more processors, cause the one or more processors to at least:
for each content item of a plurality of content items:
determine a set of user engagement history data for a user to which content items are to be presented;
determine a set of content item information data for the content item;
determine a set of contextual relevance data, including:
a query context associated with a first output channel of a plurality of output channels, and
a content relevance based on existing content items corresponding to the query context; and
generate a plurality of engagement scores by providing the set of contextual relevance data and at least one of the set of user engagement history data or the set of content item information data to a machine learning model (“ML model”), the ML model trained on user engagement data across the plurality of output channels, each of the plurality of engagement scores corresponding to an engagement action of a plurality of engagement actions; and
provide a ranked list of the content items to the first output channel, wherein the plurality of content items are ranked based at least in part on the plurality of engagement scores generated for each content item.

7. The system of claim 6, wherein the program instructions that, when executed by the one or more processors, further cause the one or more processors to at least:
for each of the plurality of content items, generate a ranking score for the content item by combining at least two of the plurality of engagement scores; and
generate the ranked list based at least in part on the ranking score generated for each content item.

8. The system of claim 6, wherein the program instructions that, when executed by the one or more processors, further cause the one or more processors to at least:
determine, for the first output channel, first output channel-specific weights for the plurality of engagement actions;
for each of the plurality of content items:
adjust at least one of the plurality of engagement scores based at least in part on the first output channel-specific weights to generate at least one weighted engagement score; and
generate a ranking score for the content item by combining the at least one weighted engagement score with at least one of the plurality of engagement scores; and
generate the ranked list based at least in part on the ranking score generated for each content item.

9. The system of claim 8, wherein the program instructions that, when executed by the one or more processors, further cause the one or more processors to at least:
automatically learn, based on historical user engagement patterns of one or more users specific to the first output channel, the first output channel-specific weights.

10. The system of claim 8, wherein the program instructions that, when executed by the one or more processors, further cause the one or more processors to at least:
periodically adjust one or more of the first output channel-specific weights to align the first output channel-specific weights with a goal of the first output channel.

11. The system of claim 6, wherein the program instructions that, when executed by the one or more processors, further cause the one or more processors to at least:
receive a second plurality of content items;
for each content item of the second plurality of content items, determine:
a second set of user engagement history data for a second user;
a second set of content item information data for the content item;
a second set of contextual relevance data, including:
a second query context associated with a second output channel of the plurality of output channels, and
a second content relevance based on existing content items associated with the second query context;
provide, as second inputs to the ML model, the second set of contextual relevance data and at least one of the second set of user engagement history data or the second set of content item information data; and
receive, from the ML model, a second plurality of engagement scores, each engagement score of the second plurality of engagement scores corresponding to an engagement action of the plurality of engagement actions; and
provide a second ranked list of the second plurality of content items to the second output channel, wherein the second plurality of content items are ranked based at least in part the second plurality of engagement scores received from the ML model for each content item of the second plurality of content items.

12. The system of claim 6, wherein the program instructions that, when executed by the one or more processors to determine the query context, further cause the one or more processors to at least:
determine, for a style-based output channel, a style category as the query context; and
determine, for a new user output channel, user demographic information as the query context.

13. The system of claim 6, wherein the program instructions that, when executed by the one or more processors, further cause the one or more processors to at least:
log user engagement actions associated with each content item presentation across the plurality of output channels.

14. The system of claim 13, wherein the program instructions that, when executed by the one or more processors, further cause the one or more processors to at least:
periodically update a training of the ML model based at least in part the logged user engagement actions.

15. A method, comprising:
receiving a content item request for a first output channel of a plurality of output channels;
obtaining candidate content items potentially responsive to the content item request;
for each candidate content item:
determining a set of user engagement history data corresponding to a user to which content items are to be presented;
determining a set of candidate content item information data corresponding to the candidate content item;
determining a set of contextual relevance data, including:
a query context associated with the first output channel;
a content relevance based on existing content items corresponding to the query context;
generating a plurality of engagement scores by providing the set of user engagement history data, the set of candidate content item information data, and the set of contextual relevance data to a machine learning model (“ML model”), the ML model trained on user engagement data across the plurality of output channels, each of the plurality of engagement scores corresponding to an engagement action of a plurality of engagement actions; and
generating a ranking score by combining at least two of the engagement scores; and
providing ranked content items to the first output channel for presentation based at least in part on the ranking scores.

16. The method of claim 15, further comprising:
generating the ML model by, at least:
obtaining training data comprising user engagement with content items presented across the plurality of output channels; and
training the ML model using at least a portion of the training data to predict engagement scores for content items.

17. The method of claim 16, further comprising:
tracking user engagement actions of a plurality of users across the plurality of output channels; and
updating the training of the ML model based at least in part on user engagement actions.

18. The method of claim 15, further comprising:
maintaining multiple candidate content item generators;
identifying a subset of the candidate content item generators based on historical performance in the first output channel; and
obtaining the candidate content items from at least one of the identified subsets of candidate content item generators.

19. The method of claim 15, further comprising:
for each candidate content item, determining a set of content item popularity score data for the candidate content item; and
wherein generating the plurality of engagement scores includes, providing the set of user engagement history data, the set of content item information data, the set of content item popularity score data, and the set of contextual relevance data to the ML model.

20. The method of claim 15, further comprising:
determining output channel-specific weights for the first output channel; and
adjusting the engagement scores using the output channel-specific weights to generate weighted engagement scores; and
wherein generating the ranking score includes combining at least two of the weighted engagement scores.
